(19) United States
(12) Patent Application Publication
(10) Pub. No.: US 2004/0136175 A1
(43) Pub. Date: Jul. 15, 2004

(54) Ultraviolet illuminated fluorescent badge

(76) Inventors: Edward D. Lewis, Brownsburg, IN (US); Daniel J. Deutsch, Orlando, FL (US)

Correspondence Address: BAHRET & ASSOCIATES, 320 NORTH MERIDIAN STREET, SUITE 512, INDIANAPOLIS, IN, 46204, US

(21) Appl. No.: 10/341,539

(22) Filed: Jan. 13, 2003

(51) Int. Cl. F21V 9/16

(52) U.S. Cl. 362/84; 362/31

(57) ABSTRACT

An illuminated display badge includes a frame surrounding a display panel that has fluorescent pigment illuminated by a UV LED. The badge includes an electrical power source such as a button cell and an electrical switch for selectively controlling the flow of electrical current between the power source and the LED. The fluorescent pigment emits visible light in response to being illuminated by ultraviolet light.

### BACKGROUND OF THE INVENTION

This invention relates to badges, name tags, advertising buttons and the like that can be pinned to the outside of a garment, and particularly to such badges and the like having a self-contained source of illumination.

It is known to provide a badge with a self-contained source of illumination to back-light a display surface bearing indicia. See, for example, U.S. Pat. No. 5,755,506 to Ray et al. Illuminated badges commonly include a lamp of the light-emitting diode (LED) or incandescent type, a battery, and an electrical switch and circuit to control the flow of current between the battery and the lamp.

### SUMMARY OF THE INVENTION

The present invention provides an illuminated badge including a display panel having fluorescent pigment illuminated by an ultraviolet (UV) LED. The badge includes an electrical power source and an electrical switch for selectively controlling the flow of electrical current between the power source and the UV LED.

Other aspects of the present invention will be apparent from the following description of preferred embodiments with reference to the accompanying drawings.

### BRIEF DESCRIPTION OF THE DRAWINGS

FIG. 1 is a front view of one embodiment of an ultraviolet illuminated badge with a display panel having fluorescent pigment.

FIG. 2 is a cross-sectional view of the badge of FIG. 1, taken in the plane 2-2 of FIG. 1 and viewed in the direction of the arrows.

FIG. 3 is a back view of the badge of FIG. 1.

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device and such further applications of the principles of the invention as illustrated therein being contemplated as would normally occur to one skilled in the art to which the invention relates.

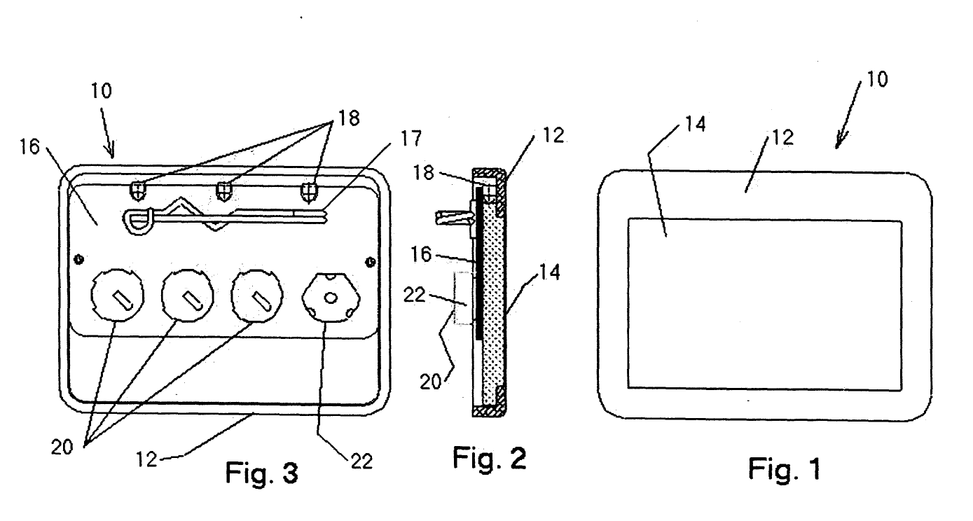

Referring to FIGS. 1-3, one embodiment of the present invention is a lighted badge 10 that includes a frame 12, a display panel 14, and an edge-lighting circuit mounted on a printed circuit (pc) board 16. The pc board is affixed to the back of the display panel and has a pin 17 mounted thereon for pinning the badge to a garment. The edge-lighting circuit may include a plurality of ultraviolet (UV) LEDs 18, a plurality of AG3, AG10 or other suitable button cells 20, and an on-off switch 22 along with associated components including current-limiting resistors for the LEDS. Alternatively, pin 17 itself may be connected electrically so as to serve as the on-off switch if desired. The LEDs may be energized under control of an integrated circuit (IC) such that alternate actuation of the on-off switch causes the LEDs to turn on and off. Display panel 14 is preferably transparent or translucent plastic. Frame 12 may also be made of plastic and may be opaque, translucent or transparent.

Display panel 14 is illuminated by the UV LEDs in an edge-lighted manner such that ultraviolet light entering the edge of the display panel is transmitted and guided throughout the plastic material of the display panel, which preferably has fluorescent pigment mixed therein prior to molding. In an alternative configuration that may be desirable for some applications, fluorescent pigment may be applied as a coating to the back or front surfaces of the display panel. The ultraviolet light excites the fluorescent pigment and causes the display panel to glow, creating a novel and pleasing aesthetic effect, and also back-lighting any indicia, design or graphics that may be on the display panel.

As one example set of suitable dimensions, the fully assembled badge of FIGS. 1-3 may have an overall height of about 40 mm and an overall width of about 50 mm, and the exposed front surface of the display panel may have a height of about 25 mm and a width of about 40 mm. It will be understood that display badges of other sizes and proportions are also contemplated.

UV LEDs 18 emit light having a wavelength in the range of about 390 to about 410 nm, more preferably having a peak of about 390 nm to about 410 nm, and most preferably having a peak of about 400 nm. A suitable UV LED is the DL50PLDW503 UV LED available from Shue Kwong Optic Electronic Company, Shenzhen, China. The ultraviolet light is collected by an edge of display panel 14 and transmitted throughout the plastic material of the panel. The plastic material of display panel 14 may be a polycarbonate material that is mixed with fluorescent pigment and injection molded into the shape of a planar sheet with rabbeted edges for receiving the frame such that the display panel is substantially flush with the front surface of the frame. Alternatively, the plastic material may be polystyrene, PVC, ABS or acrylic materials. The pigment may be mixed at a ratio of about 1 to 2 grams of pigment per kilogram of plastic material. The fluorescent pigment may be a pigment that is commercially available from Wen Lee Plastic Pigment Company, Tungguong, China, such as Part No. 61113 (green), Part No. 31461 (blue), Part No. 238 (red), or Part No. 2600 (yellow).

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. For example, it is also contemplated that fluorescein dye may be mixed with ink to be applied to the display panel to form a logo or other indicia desired to be illuminated.

What is claimed is:

1. An illuminated display badge comprising:
a planar display panel having fluorescent pigment;
at least one ultraviolet light-emitting diode proximate an edge of the display panel to illuminate the fluorescent pigment;
an electrical power source; and
an electrical switch for selectively controlling the flow of electrical current between the power source and light-emitting diode.

2. The illuminated display badge of claim 1, wherein the display panel is translucent or transparent.

3. The illuminated display badge of claim 2, further comprising a frame in which the display panel is received.

4. The illuminated display badge of claim 3, wherein the fluorescent pigment of the display panel emits visible light in response to being illuminated by ultraviolet light from the light-emitting diode.

5. The illuminated display badge of claim 4, wherein the ultraviolet light-emitting diode emits light having a peak wavelength in the range of about 390 nm to about 410 nm.

6. The illuminated display badge of claim 5, wherein the ultraviolet light-emitting diode emits light having a peak wavelength of about 400 nm.
